(19) United States
(12) Patent Application Publication
(10) Pub. No.: US 2004/0026991 A1
(43) Pub. Date: Feb. 12, 2004

(54) Traction control system

(75) Inventors: Hidetoshi Suzuki, Shizuoka-ken (JP); Tomoyuki Kikuta, Aichi-ken (JP); Eiji Ina, Aichi-ken (JP)

Correspondence Address: CARSTENS YEE & CAHOON, LLP, P O BOX 802334, DALLAS, TX, 75380

(73) Assignee: ASMO CO., LTD., Shizuoka-ken (JP)

(21) Appl. No.: 10/635,370

(22) Filed: Aug. 6, 2003

(30) Foreign Application Priority Data
Aug. 8, 2002 (JP) 2002-231221

(51) Int. Cl. B60T 8/34

(52) U.S. Cl. 303/113.2; 303/20

(57) ABSTRACT

A traction control system has electric braking devices, each of which is provided for one of the drive wheels of a vehicle and applies brake to the corresponding drive wheel. Rotational speeds of the drive wheels are detected by rotational speed sensors. When the difference between the rotational speeds detected by the rotational speed sensors exceeds a predetermined permissible value, an ECU determines that the faster wheel is slipping. Then, the ECU causes the electric braking device that corresponds to the slipping drive wheel to generate braking force. As a result, a traction control system of low cost and having no operational trouble is obtained.

### BACKGROUND OF THE INVENTION

The present invention relates to a traction control system of a vehicle.

In the case where the vehicle runs on a slippery road surface such as a muddy or wet road surface or a frozen road, drive wheels are apt to slip. In particular, when only one of the drive wheels is on such a road surface of a low friction coefficient on a start, the vehicle may fail to start because the drive wheel on the road surface of the low friction coefficient spins due to a differential mechanism of the vehicle and a driving torque is not conveyed to the other drive wheel.

The traction control system (hereafter, referred to as TCS) has been previously known as a system that detects a difference in rotational speed between wheels, and controls the driving torque or applying brake to a slipping drive wheel, thereby preventing the wheel from spinning and improving the start, acceleration and run stability.

For instance, the TCS disclosed in Japanese Laid-Open Patent Publication No. 5-155321 cuts off communication between a master cylinder and a wheel cylinder of a hydraulic brake and supplies a brake fluid pressure-regulated by a regulation valve to the wheel cylinder of the slipping drive wheel. To be more specific, it prevents a driving slip by applying brake to the slipping drive wheel.

The TCS disclosed in Japanese Laid-Open Patent Publication No. 7-291113 couples an equalizer oscillation mechanism to an operation cable of a parking brake, and connects both ends of the equalizer to a brake lever of both drive wheels. And the equalizer is oscillated to apply a brake to the slipping drive wheel so as to prevent the driving slip.

However, the TCS by means of driving torque regulation requires higher cost because complicated engine control must be exerted. Even in the case of the TCS by applying a brake to the slipping drive wheel, the TCS of Japanese Laid-Open Patent Publication No. 5-155321 requires a hydraulic regulator in a brake fluid circuit to be provided and reliability of water pressure to be secured. For that reason, the structure becomes complicated and manufacturing cost becomes high. The TCS in Japanese Laid-Open Patent Publication No. 7-291113 has a simple structure. However, there are problems that there may arise Taxation to the cable connected to the drive wheel to which the brake is not applied due to the oscillation of the above described equalizer, and the cable may come off the brake lever.

### SUMMARY OF THE INVENTION

An object of the present invention is to provide a traction control system of low cost and having no operational trouble.

To achieve the foregoing and other objectives and in accordance with the purpose of the present invention, a traction control system for a vehicle having left and right drive wheels is provided. The system includes a pair of electric braking devices, a slip detection device, and a controller. Each electric braking device corresponds to one of the drive wheels, and applies brake to the corresponding drive wheel. The slip detection device detects slipping of the drive wheels. The controller controls the electric braking devices. Based on a result of detection by the slip detection device, the controller causes the electric braking device that corresponds to slipping one of the drive wheels to generate braking force.

Other aspects and advantages of the invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a schematic block diagram of a vehicle having a traction control system according to a first embodiment of the present invention;

FIG. 2 is a schematic block diagram of an electric braking device in FIG. 1;

FIG. 3 is a schematic block diagram showing an electrical configuration of the traction control system in FIG. 1;

FIG. 4 is a schematic block diagram of the vehicle having a traction control system according to a second embodiment of the present invention;

FIG. 5 is a schematic block diagram of the electric braking device in FIG. 4;

FIG. 6 is a graph showing a relationship between a braking force generated by the electric braking device and a position of a frictional member;

FIG. 7 is a graph showing an operation of the traction control system in FIG. 4;

FIG. 8 is a flowchart showing a control procedure of the traction control system in FIG. 4;

FIG. 9 is a graph showing a form of traction control in a converted example; and

FIG. 10 is a schematic block diagram showing the electrical configuration of the traction control system in a converted example.

### DETAILED DESCRIPTION OF THE PREFERRED EMBODIMENTS

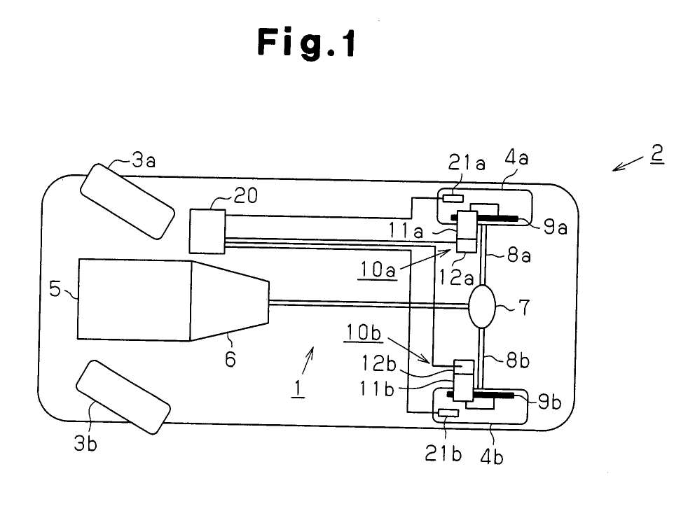

Hereafter, a first embodiment of the present invention will be described according to FIGS. 1 to 3.

FIG. 1 is a schematic block diagram of a vehicle 2 having a traction control system 1 according to the present invention.

As shown in FIG. 1, the vehicle 2 in this embodiment is a rear-wheel-drive vehicle of which front wheels are steered wheels 3a and 3b and rear wheels are drive wheels 4a and 4b. A driving force of an engine 5 is decelerated by a transmission 6 and conveyed to the right and left drive wheels 4a and 4b via a differential gear 7. The differential gear 7 has a function of, in the case where a difference in rotational speed such as an inner ring difference on cornering arises between the right and left drive wheels 4a and 4b, adjusting the difference in the rotational speed by allocating a driving torque of any drive wheel having slower rotational speed to the other drive wheel having faster rotational speed.

The drive wheels 4a and 4b have discelectric braking devices 10a and 10b. As for this embodiment, electric parking brake apparatuses are used as the electric braking devices 10a and 10b.

The electric braking devices 10a and 10b each have a rotor, which is a disc 9a, 9b, a braking portion 11a, 11b, and an actuator 12a, 12b. The discs 9a, 9b are fixed to axles 8a, 8b of the drive wheels 4a, 4b, respectively. The braking portions 11a and 11b apply brake to the discs 9a and 9b with the driving force generated by the actuators 12a and 12b.

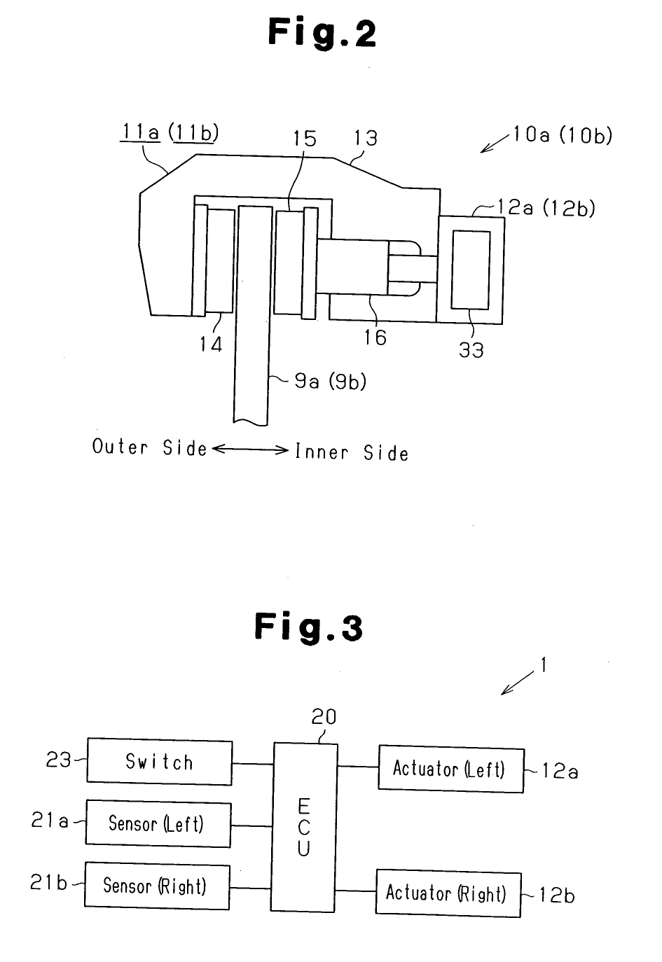

FIG. 2 is a schematic block diagram of an electric braking device 10a. As the electric braking devices 10a and 10b have the same configuration, the configuration of one electric braking device 10a will be described.

The electric braking devices 10a is a caliper-floating type parking disc brake, and the braking portion 11a has a brake caliper 13, brake pads 14 and 15, and a piston 16. The brake pads 14, 15 function as frictional members.

The brake caliper 13 is supported to be limitedly movable within a predetermined range against a bracket (not shown) rotatably supporting the axle 8a in an axial direction of the axle. The brake caliper 13 has brake pads 14 and 15 placed at positions opposed to the respective sides (outer side, inner side) of the disc 9a fixed on the above described axle 8a. The brake pad 14 on the outer side is fixed on the outer side of the brake caliper 13, and the brake pad 15 on the inner side is movably supported on the inner side of the brake caliper 13 in a direction for contacting or leaving the disc 9a.

The brake pad 15 on the inner side contacts and leaves the disc 9a by reciprocating motion of a piston 16 equipped on the inner side of the brake caliper 13. And as for the electric braking device 10a which is such a disc brake of the caliper-floating type, if the brake pad 15 on the inner side is pressure-welded to the disc 9a by operation of the piston 16, the brake caliper 13 moves to the inner side in the axial direction due to a reaction force generated then so that the brake pad 14 on the outer side is pressure-welded to the disc 9a.

The actuators 12a and 12b each includes an electric motor 33 and a motion converter for converting rotation of the electric motor 33 to linear reciprocation of an output shaft. The output shaft of each actuator 12a, 12b is directly coupled to the corresponding piston 16. As each actuator 12a, 12b moves the corresponding piston 16, the corresponding brake pads 14, 15 contact and separate from the corresponding disc 9a, 9b.

As shown in FIG. 1, the traction control system 1 has an electronic control unit (ECU) 20, which functions as controller, and rotational speed sensors 21a and 21b for the right and left drive wheels 4a and 4b. The rotational speed sensors 21a and 21b, together with the ECU 20, function as a slip detection device for detecting slipping of each of the drive wheels 4a, 4b. Alternatively, the rotational speed sensors 21a and 21b, and the ECU 20 function as a spinning detection device for detecting spinning each of the drive wheels 4a, 4b. The rotational speed sensors 21a, 21b, and the actuators 12a,12b are connected to the ECU 20.

FIG. 3 is a schematic block diagram showing an electrical configuration of the traction control system 1. The rotational speed sensors 21a and 21b and the actuators 12a and 12b are connected to the ECU 20. The rotational speed sensors 21a and 21b detect the rotational speeds of the right and left drive wheels 4a and 4b respectively, and outputs them to the ECU 20. The ECU 20 compares the outputted rotational speeds of the right and left drive wheels 4a and 4b to determine a slip state thereof. And if determined that either one of the right and left drive wheels 4a and 4b is in the slip state, the ECU 20 operates the actuators 12a and 12b of the one having a higher rotational speed of the drive wheels 4a and 4b.

The ECU 20 is connected to a manual switch 23 provided in a passenger compartment (not shown) the vehicle 2. The switch 23 is provided at a position operable by an occupant of the vehicle 2. When an occupant turns the switch 23 on and off, the ECU 20 selectively activates and deactivates the traction control.

Next, a description will be given as to the operation of the traction control system 1 constituted as above.

In the case where a slip occurs to either one of the drive wheels 4a and 4b of the vehicle 2, on occurrence of the slip to the drive wheel 4a (located toward the upper side in FIG. 1) for instance, the driving torque of another drive wheel 4b (located toward the lower side in FIG. 1) is distributed to the slipping drive wheel 4a due to the action of the above described differential gear 7.

In the case where a slip occurs while running, there are the cases where the vehicle 2 makes an inertial move so that it gets out of a road surface of a low friction coefficient and the drive wheel 4a recovers a grip. In that case, the driving torque is distributed to the slipping drive wheel 4b again. However, in the case where the drive wheel 4a cannot get out of the road surface of the low friction coefficient, especially when only the drive wheel 4a is in contact with the road surface of the low friction coefficient on a start, the drive wheel 4a spins and all the driving torque is distributed to the drive wheel 4a spinning so that the vehicle 2 can no longer move.

Such a slip state is detected by the ECU 20 as a difference in the rotational speed between the drive wheels 4a and 4b from the rotational speed sensors 21a and 21b. In this case, the rotational speed of the slipping drive wheel 4a is apparently higher than that of the drive wheel 4b which is not slipping. To be more specific, the ECU 20 compares the rotational speeds of the drive wheels 4a and 4b outputted from the rotational speed sensors 21a and 21b. If the difference between the rotation speeds exceeds a predetermined permissible value, the ECU 20 determines that the slip is occurring to the drive wheel 4a of which rotational speed is higher.

On detecting slipping of the drive wheel 4a, the ECU 20 operates the actuator 12a coupled to the electric braking device 10a of the drive wheel 4a, thereby applying brake to the drive wheel 4a. As a result, the differential gear 7 redistributes the driving torque from the drive wheel 4a to the drive wheel 4b. To describe it in detail, the driving torque, which has been transmitted to the drive wheel 4a but is originally supposed to be transmitted to the drive wheel 4b, is redistributed to the drive wheel 4b by the differential gear.

At that time, the ECU 20 monitors the difference in the rotational speed between the drive wheels 4a and 4b outputted from the rotational speed sensors 21a and 21b, and intermittently repeats braking of the intermittently slipping drive wheel 4a. To describe it in detail, if the difference in the rotational speed is equal to or less than the permissible value (within a range of the difference in the rotational speed due to the inner ring difference, for instance) allowed at a non-slip time due to the braking of the drive wheel 4a, the braking of the drive wheel 4a is released. In the case where the difference in the rotational speed between the drive wheels 4a and 4b exceeds the permissible value again due to the release of the braking, the brakes are applied to the slipping drive wheel 4a by operating the actuator 12a corresponding to the drive wheel 4a again.

And the ECU 20 repeats the braking of the drive wheel 4a and the release of the braking until the vehicle 2 is moved by the rotation of the drive wheel 4b and the difference in the rotational speed between the drive wheels 4a and 4b falls to or below the permissible value.

The above embodiment has the following advantages.

(1) According to this embodiment, the electric braking devices 10a and 10b and rotational speed sensors 21a and 21b are provided to the drive wheels 4a and 4b. The rotational speed sensors 21a and 21b are connected to the ECU 20, and the ECU 20 has the actuators 12a and 12b coupled to the electric braking devices 10a and 10b connected thereto. And the ECU 20 compares the rotational speeds of the drive wheels 4a and 4b outputted from the rotational speed sensors 21a and 21b, and operates the slipping actuators 12a and 12b so as to apply brake to the slipping drive wheels 4a and 4b. Consequently, the manufacturing cost can be held down because of the simple configuration.

(2) According to this embodiment, the electric parking brake apparatus is used as the electric braking device 10a. Subsequently, the brake apparatus not used while running is used so that a traction control function can be obtained while holding down additional costs to below.

(3) It has a configuration wherein the electric braking devices 10a and 10b are operated by the actuators 12a and 12b coupled thereto respectively. Consequently, it is possible to apply brake only to the drive wheel in need of the braking independently of the other drive wheel so as to avoid a problem due to the operation.

(4) When the difference between the rotational speeds of the drive wheels 4a and 4b exceeds the permissible value, the ECU 20 causes one of the electric braking devices that corresponds to the faster drive wheel to apply brake to the faster drive wheel. If, as a result of application of brake, the rotational speed difference falls to or below the permissible value, the ECU 20 causes the electric braking device to stop applying brake. If, as a result of stopping applying brake, the rotation speed difference between the drive wheels 4a, 4b exceeds the permissible value, the ECU 20 again causes one of the electric braking devices that corresponds to the faster drive wheel to apply brake to the faster drive wheel. As a result, excessive application of brake to the drive wheels is prevented, and the drive wheels 4a, 4b are not stopped due to braking.

(5) In the passenger compartment of the vehicle 2, the switch 23 connected to the ECU 20 is provided at the position operable by an occupant. Based on the state of the switch 23, the ECU 20 selectively activates and deactivates the traction control. In other words, the ECU 20 selectively activates and deactivates control of the electric braking devices 10a, 10b according to slipping. For example, when the switch 23 is on, the traction control is executed according to slipping of the drive wheels 4a, 4b. When the switch 23 is off, the traction control is not executed even if the drive wheels 4a, 4b slip. The occupant can freely determine whether to execute the traction control by manipulating the switch 23.

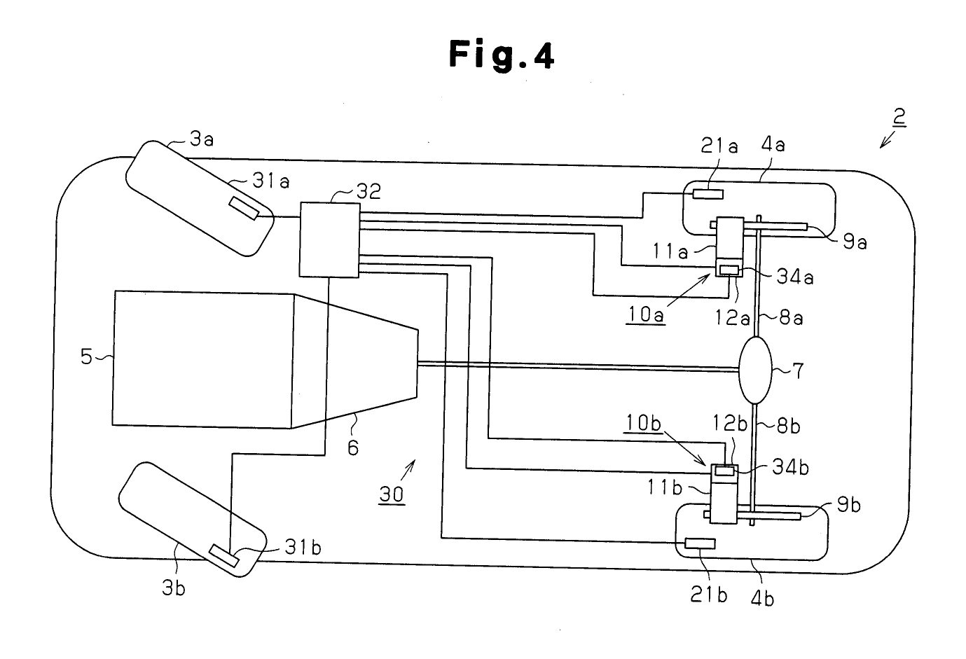

Hereafter, a second embodiment concretizing the present invention will be described according to FIGS. 4 to 8. The same portions as those in the first embodiment will be given the same symbols, and a description thereof will be omitted.

As shown in FIG. 4, a traction control system 30 according to this embodiment has rotational speed sensors 31a and 31b for detecting a rotational state of the right and left steered wheels 3a and 3b as non-drive wheels. The rotational speed sensors 31a and 31b are connected to an ECU 32. The ECU 32 detects the rotational state of the steered wheels 3a and 3b based on inputs from the rotational speed sensors 31a and 31b.

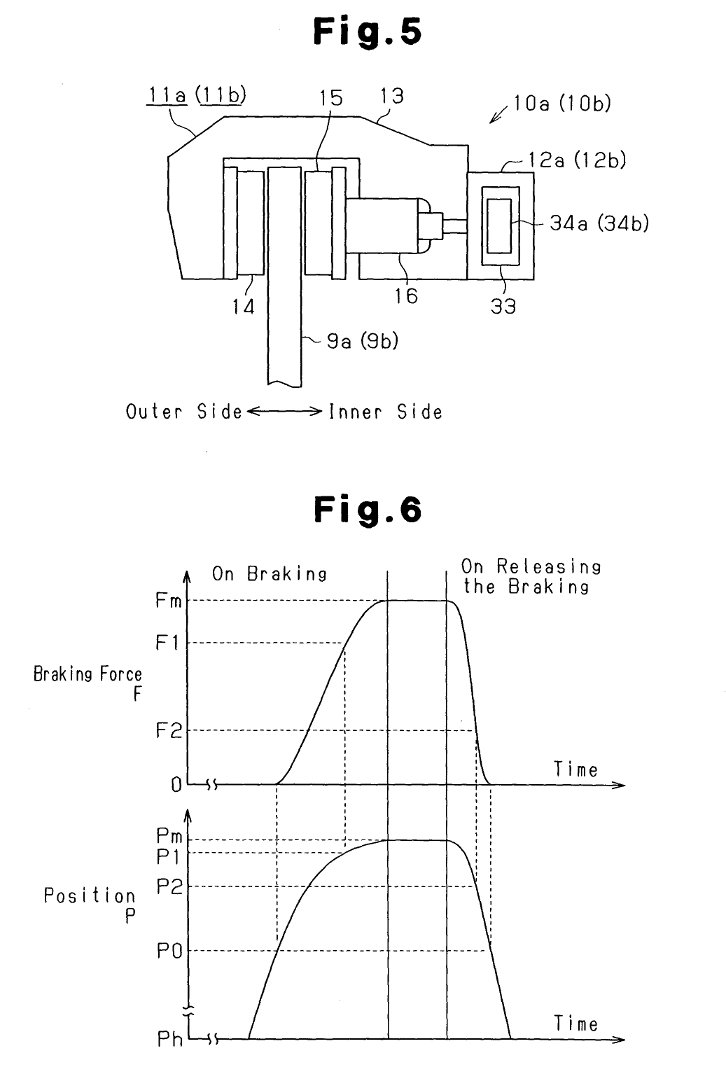

As shown in FIGS. 4 and 5, pulse generators 34a and 34b are provided for a motor (electric motor) 33 which is a driving source of the actuators 12a and 12b. The pulse generators 34a and 34b are connected to the ECU 32.

According to this embodiment, the ECU 32 counts pulse signals inputted from the pulse generators 34a and 34b to detect the positions of the brake pads 14 and 15 as frictional members. The ECU 32 as a braking force estimation means estimates the braking force generated by the electric braking devices 10a and 10b based on the detected positions of the brake pads 14 and 15.

To describe it in detail, the pulse generators 34a and 34b are comprised of ring magnets and hole ICs which are not shown. In the pulse generators 34a and 34b, the ring magnet is mounted so that a flux passing through the hole IC by means of the rotation of the motor 33 periodically changes, and the pulse generators 34a and 34b output the pulse signals of which level changes according to the rotation of the motor 33 to the ECU 32.

The ECU 32 counts the number of pulses of the pulse signals (rotation signals) inputted from the pulse generators 34a and 34b, and multiplies the rotation number of the motor detected based on the count number by a moving distance of the brake pads 14 and 15 per rotation so as to detect the positions of the brake pads 14 and 15. The ECU 32 estimates the braking force generated by the electric braking devices 10a and 10b based on the detected positions of the brake pads 14 and 15.

To be more precise, on parking braking as shown in FIG. 6 for instance, the electric braking devices 10a and 10b move by means of the rotation of the motor 33 in a direction in which the brake pads 14 and 15 approach the disc 9a (9b) as a body of rotation from a basic position Ph, and generate the braking force in time by pressure-welding the disc 9a (9b).

To be more specific, the electric braking devices 10a and 10b do not generate the braking force in an idle running section in which the brake pads 14 and 15 move from the basic position Ph to the position contacting the disc 9a (9b) (braking start position P0), and generate the braking force for the first time in the case where the brake pads 14 and 15 are at the braking start position P0.

The braking force generated by the electric braking devices 10a and 10b increases as the brake pads 14 and 15 further move and pressure-weld the disc 9a (9b). And in the case where the brake pads 14 and 15 move to the position where they cannot move any more (maximum braking position Pm), the braking force generated by the electric braking devices 10a and 10b becomes a maximum braking force Fm.

When releasing the braking, the braking force generated by the electric braking devices 10a and 10b decreases as the brake pads 14 and 15 move in a direction in which they are spaced apart from the disc 9a (9b) due to reverse rotation of the motor 33 so as to become zero when the brake pads 14 and 15 move further toward the basic position Ph than the braking start position P0.

According to this embodiment, the ECU 32 detects which positions between the braking start position P0 and maximum braking position Pm the brake pads 14 and 15 are at based on the pulse signals inputted from the pulse generators 34a and 34b so as to estimate the braking force generated by the electric braking devices 10a and 10b.

According to this embodiment, the data showing the relationship between a position P of the brake pads 14 and 15 and a braking force F generated by the electric braking devices 10a and 10b is acquired in advance by an experiment (including calculation and simulation) and stored in a storage device not shown. The ECU 32 refers to this data as required.

Next, a description will be given as to an embodiment of the traction control by the traction control system 30 according to this embodiment.

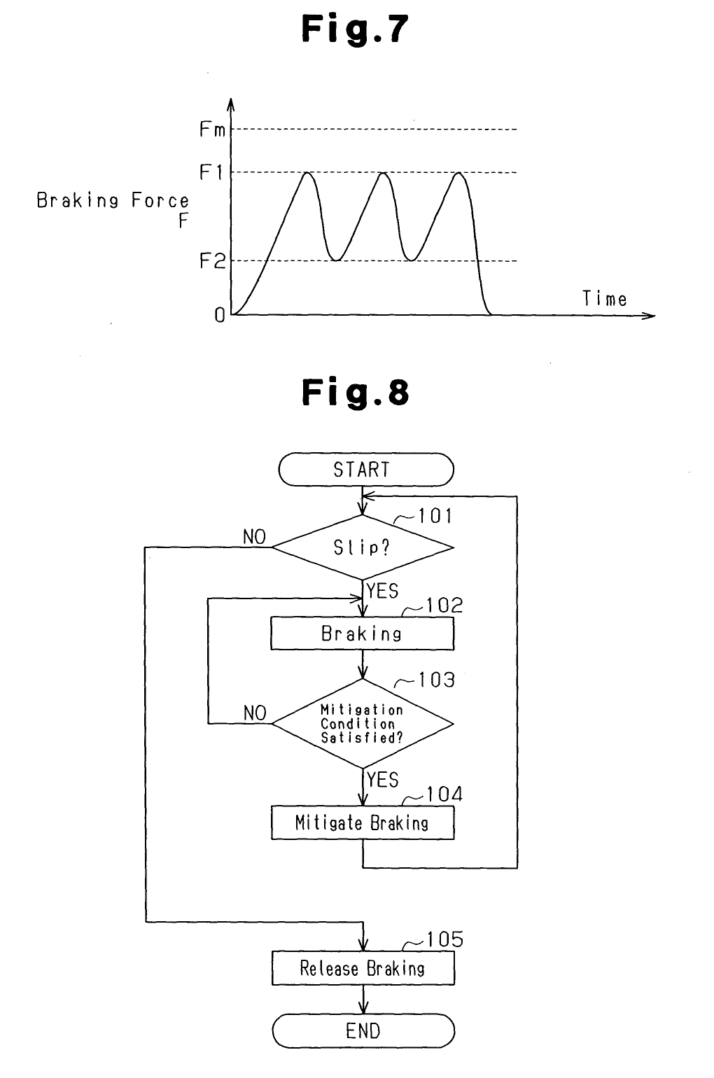

As shown in FIG. 7, in the case of detecting any slip state (spinning state) of either one of the drive wheels 4a and 4b, the traction control system 30 according to this embodiment provides a first braking force F1 which is weaker than the maximum braking force Fm to that spinning drive wheel (spinning wheel). To be more precise, the ECU 32 moves the brake pads 14 and 15 of the electric braking devices 10a and 10b corresponding to the spinning wheel toward a first position P1 for generating the first braking force F1 so as to exert control to have the first braking force F1 generated by the electric braking devices 10a and 10b corresponding to the spinning wheel. According to this embodiment, the braking force necessary to stop the spinning wheel is set up as the first braking force F1.

Next, in the case where a predetermined mitigation condition holds, the traction control system 30 mitigates the braking force to be given to the spinning wheel to be a second braking force F2, which is weaker than the first braking force F1. According to this embodiment, the mitigation condition refers to any one the following three conditions: a first condition in which the drive wheel to which brake is being applied stops; a second condition in which the drive wheel that is not spinning, or the drive wheel to which brake is not being applied, rotates; and a third condition in which the steered wheels 3a, 3b, which are non-drive wheels (coasting wheels) rotate. When at least one of the three conditions holds, the traction control system 30 mitigates the braking force to be given to the spinning wheel to be the second braking force F2.

To be more precise, in the case where at least one of the three conditions holds, the ECU 32 exerts control to move the brake pads 14 and 15 of the electric braking device 10a, 10b that corresponds to the spinning wheel to a second position P2 for generating the second braking force F2 so as to have the second braking force F2 generated by the electric braking device 10a, 10b that corresponds to the spinning wheel. To be more specific, the braking force to be given to the spinning wheel is mitigated. According to this embodiment, the braking force to the extent of not stopping the rotation of the drive wheels 4a and 4b is set up as the second braking force F2.

And in the case where the slip state is not resolved after mitigating the braking force, the traction control system 30 provides the first braking force F1 to the spinning drive wheel again until the mitigation condition holds so as to repeat the braking and braking mitigation until the slip state is resolved. And in the case where the slip state is resolved, the traction control system 30 releases the braking. To be more precise, the ECU 32 exerts control to move the brake pads 14 and 15 of the electric braking device 10a, 10b that corresponds to the spinning wheel to the basic position Ph (refer to FIG. 6).

According to this embodiment, the first braking force F1 and the second braking force F2 are acquired in advance by the experiment (including calculation and simulation) and stored in the storage device not shown as with the data showing the relationship between the position P of the brake pads 14 and 15 and the braking force F generated by the electric braking devices 10a and 10b.

Next, a description will be given as to the form of the traction control according to this embodiment.

As shown in FIG. 8, the ECU 32 first determines whether or not one of the drive wheels 4a and 4b is in the slip state based on the difference in the rotational speed between the drive wheels 4a and 4b inputted from the rotational speed sensors 21a and 21b (step 101).

If determined that one of the drive wheels 4a and 4b is in the slip state (spinning state) in the step 101, the ECU 32 exerts control to have the first braking force F1 generated by the electric braking device 10a, 10b that corresponds to the the spinning wheel (step 102).

Next, the ECU 32 determines whether or not the predetermined mitigation condition holds (step 103). To be more precise, the ECU 32 determines whether each of the three conditions is satisfied based on the rotation speeds of the drive wheels 4a, 4b and the rotation speeds of the steered wheels 3a, 3b sent from the rotational speed sensors 21a, 21b, 31a, 31b. That is, the ECU 32 determines whether the drive wheel to which brake is currently applied has stopped, whether the drive wheel to which brake is not applied rotates, and whether the steered wheels 3a, 3b rotate.

The ECU 32 repeats the steps 102 and 103 until at least one of the three conditions holds so as to exert control to have the first braking force generated by the electric braking device 10a, 10b that corresponds to the spinning wheel.

Next, if determined that the mitigation condition holds in the step 103, the ECU 32 exerts control to have the second braking force F2 generated by the electric braking device 10a, 10b that corresponds to the spinning wheel and mitigates the braking force to be given to the spinning wheel (step 104). Then, it returns to the step 101 to determine whether or not the slip state is resolved so as to repeat the process of the steps 101 to 104 until the slip state is resolved.

If determined that the slip state is resolved in the step 101, the ECU 32 exerts control to return the positions of the brake pads 14 and 15 of the electric braking device 10a, 10b that corresponds to the spinning wheel to the basic position Ph, and then releases the braking (step 105).

The above embodiment has the following advantages.

(1) In the case of any slip state (spinning state) of either one of the drive wheels 4a and 4b, the traction control system 30 provides the first braking force F1 which is weaker than the maximum braking force Fm on the parking braking to that spinning drive wheel (spinning wheel). To be more precise, the ECU 32 exerts control to move the brake pads 14 and 15 of the electric braking device 10a, 10b that corresponds to the spinning wheel to the first position P1 for generating the first braking force F1 so as to have the first braking force F1 generated by the electric braking devices 10a, 10b that corresponds to the spinning wheel.

Given such a configuration, the brake pads 14 and 15 move only to the first position P1 on the braking. To be more specific, the moving distance of the brake pads 14 and 15 becomes shorter compared to the cases where the brake pads 14 and 15 move to the maximum braking position Pm for generating the maximum braking force Fm. Therefore, in the case of repeating the braking and release (mitigation) thereof on exerting the traction control, a response speed of the electric braking devices 10a and 10b becomes higher. Consequently, it is possible to efficiently control the traction of the drive wheels 4a and 4b so as to improve overall traction control performance.

(2) When the predetermined mitigation condition holds, the traction control system 30 mitigates the braking force to be given to the spinning wheel to be the second braking force F2 which is weaker than the first braking force F1. To be more precise, the ECU 32 exerts control to move the brake pads 14 and 15 of the electric braking device 10a, 10b that corresponds to the spinning wheel to the second position P2 for generating the second braking force F2 so as to have the second braking force F2 generated by the electric braking device 10a, 10b that corresponds to the spinning wheel.

Given such a configuration, the brake pads 14 and 15 move only from the first position P1 to the second position P2 on mitigating the braking. To be more specific, the moving distance of the brake pads 14 and 15 becomes shorter compared to the cases where the brake pads 14 and 15 are returned to the basic position Ph for the sake of completely releasing the braking and rendering the braking force as zero. Therefore, in the case of repeating the braking and mitigation thereof on exerting the traction control, the response speed of the electric braking devices 10a and 10b becomes higher. Consequently, it is possible to efficiently control the traction of the drive wheels 4a and 4b so as to improve the overall traction control performance.

The braking force to the extent of not stopping the rotation of the drive wheels 4a and 4b is set up as the second braking force F2, and the braking force is given to the spinning one of the drive wheels 4a and 4b even when the braking is mitigated so as to prevent rapid change in the driving torque distributed to the spinning drive wheel. Consequently, it is possible to prevent the drive wheel from slipping again due to the rapid change in the driving torque.

The above embodiment may be modified as follows.

According to the second embodiment, when at least one of the three conditions holds, the traction control system 30 may mitigate the braking force to be given to the spinning wheel.

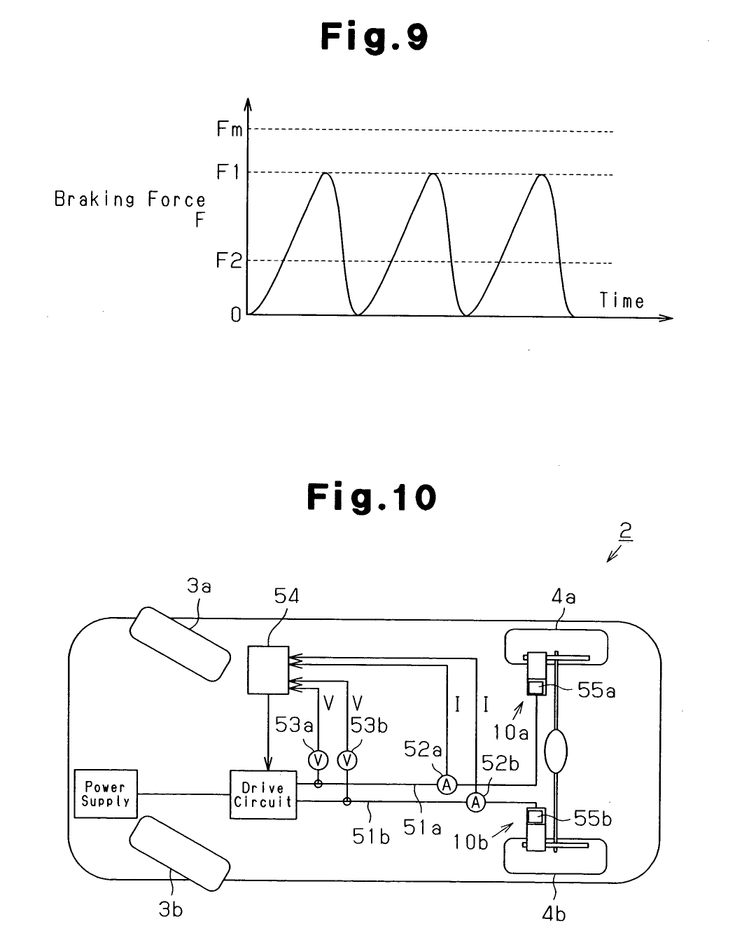

However, as shown in FIG. 9, when at least one of the three conditions holds, the ECU 32 may move the brake pads 14 and 15 to the braking start position (braking standby position) P0 at which the braking force becomes zero (refer to FIG. 6). The ECU 32 may then keep the electric braking devices 10a and 10b in a braking standby state until the drive wheels 4a and 4b that are stopped by the first braking force F1 start rotating. And in the case where the slip state is not resolved, it may control the electric braking devices 10a and 10b so as to generate the first braking force F1 until the predetermined mitigation conditions holds again.

Thus, the brake pads 14 and 15 move only from the first position P1 to the braking start position P0. To be more specific, the moving distance of the brake pads 14 and 15 becomes shorter compared to the cases where the brake pads 14 and 15 are returned to the basic position Ph. Therefore, in the case of repeating the braking and release thereof on exerting the traction control, the response speed of the electric braking devices 10a and 10b becomes higher. Thus, it is possible, by having such a configuration, to efficiently control the traction of the drive wheels 4a and 4b so as to improve the overall traction control performance.

According to the second embodiment, the pulse generators 34a and 34b are provided for the motor 33 which is the driving source of the actuators 12a and 12b. And the ECU 32 detects which positions between the braking start position P0 and maximum braking position Pm the brake pads 14 and 15 are at based on the pulse signals inputted from the pulse generators 34a and 34b so as to estimate the braking force generated by the electric braking devices 10a and 10b.

However, a traction control system 50 shown in FIG. 10, for instance, has current sensors 52a, 52b and voltage sensors 53a, 53b, which are located in power supply circuits 51a, 51b for the electric braking devices 10a and 10b. The current sensors 52a, 52b each detect a value I of current supplied to the corresponding one of motors 55a, 55b. The voltage sensors 53a, 53b each detect a value V of voltage supplied to the corresponding one of the motors 55a, 55b. An ECU 54 estimates the braking force generated by the electric braking devices 10a and 10b based on the detected current value I, the detected voltage value V, and energization period T of each of the motors 55a, 55b. Alternatively, the ECU 54 may estimate the braking force F based on at least one of the position P of the brake pads 14 and 15, the current value I, the voltage value V, and the energization period T.

According to the second embodiment, the ECU 32 counts the pulse signals inputted from the pulse generators 34a and 34b to detect the positions of the brake pads 14 and 15 as the frictional members. However, it is not limited thereto but a detection method thereof may be any method such as directly detecting the positions of the brake pads 14 and 15.

According to the above embodiments, the caliper-floating type parking disc brakes are used as the electric braking devices 10a and 10b. However, it is not limited thereto but, they do not need to be the caliper-floating type and they may be drum brakes instead of the disc brakes. The electric braking devices 10a and 10b may be the braking apparatuses dedicated to the traction control system instead of the parking brakes.

According to the above embodiments, the vehicle 2 is a rear-wheel-drive vehicle. However, it may be either a front-wheel-drive vehicle or a four-wheel drive vehicle. In that case, the electric braking devices 10a and 10b may be provided for any drive wheel instead of the rear wheel.

According to the above embodiments, the actuators 12a and 12b are directly coupled to the pistons 16 of the electric braking devices 10a and 10b. However, it is not limited thereto but the actuators 12a and 12b may be placed at locations other than the electric braking devices 10a and 10b so as to couple the output axes thereof to the pistons 16 of the electric braking devices 10a and 10b with a wire, a hydraulic line or the like.

According to the first embodiment, the rotational speed sensors 21a and 21b are provided for the right and left drive wheels 4a and 4b. However, it is not limited thereto but the rotational speed sensors may be provided for the steered wheels 3a and 3b.

In the case where the rotational speed sensors are provided for the steered wheels 3a and 3b, the driving torque may be reduced by applying brake to at least one of the drive wheels 4a and 4b if the rotational speed of the drive wheels 4a, 4b is apparently higher than the rotation speed of the steered wheels 3a, 3b.

While the above embodiments are concretized as the traction control system by using the electric braking devices, they may be concretized as a four-wheel steering system. To be more specific, according to the embodiments, the traction control is exerted by applying brake to the drive wheels of a high rotational speed. It can be concretized as the four-wheel steering system by further connecting a speed sensor, a steered wheel angle of a steered wheel and so on to the ECU 20 and applying brake to the individual steered wheels 3a and 3b and drive wheels 4a and 4b separately. For instance, in the case of a low speed and a large steering angle, it is possible to reduce a turning radius of the vehicle 2 by applying brake only to the wheels closer to the inner ring. It is also possible, depending on a control method, to stabilize the vehicle 2 on the contrary.

Therefore, the present examples and embodiments are to be considered as illustrative and not restrictive and the invention is not to be limited to the details given herein, but may be modified within the scope and equivalence of the appended claims.

1. A traction control system for a vehicle having left and right drive wheels, the system comprising:
a pair of electric braking devices, wherein each electric braking device corresponds to one of the drive wheels, and applies brake to the corresponding drive wheel;
a slip detection device for detecting slipping of the drive wheels;
a controller for controlling the electric braking devices, wherein, based on a result of detection by the slip detection device, the controller causes the electric braking device that corresponds to slipping one of the drive wheels to generate braking force.

2. The traction control system according to claim 1, wherein the electric braking devices are electric parking brake devices.

3. The traction control system according to claim 1, wherein the slip detection device includes rotational speed sensors, each of which detects rotational speed of one of the drive wheels, and wherein, based on rotational speeds detected by the rotational speed sensors, the controller determines whether each drive wheel is slipping.

4. The traction control system according to claim 3, wherein, based on whether a difference between rotational speeds of the drive wheels exceeds a predetermined permissible value, the controller determines whether each drive wheel is slipping.

5. The traction control system according to claim 4, wherein, when the difference between rotational speeds of the drive wheels exceeds the permissible value, the controller causes the electric braking device corresponding to the faster drive wheel to apply brake to the faster drive wheel, and wherein, when the rotational speed difference falls to or below the permissible value as a result of the application of brake to the drive wheel, the controller causes the electric braking device to stop applying brake.

6. The traction control system according to claim 1, wherein the controller causes the electric braking device corresponding to the slipping drive wheel to generate a first braking force, the first braking force being less than a maximum value of the braking force generated by the electric braking device.

7. The traction control system according to claim 6, wherein, until at least one of three conditions, which are: a first condition in which the drive wheel to which brake is being applied stops; a second condition in which the drive wheel to which brake is not being applied rotates; and a third condition in which a non-drive wheel of the vehicle rotates, is satisfied, the controller causes the electric braking device corresponding to the slipping drive wheel to generate the first braking force.

8. The traction control system according to claim 7, wherein, when at least one of the first to third conditions is satisfied, the controller reduces the braking force generated by the electric braking device from the first braking force to a second braking force, the second braking force being less than the first braking force.

9. The traction control system according to claim 8, wherein, when the drive wheel to which brake is being applied with the second braking force has not stopped slipping, the controller again increases the braking force generated by the electric braking device to the first braking force, and wherein, when the drive wheel to which brake is being applied with the second braking force has stopped slipping, the controller causes the electric braking device to stop applying brake.

10. The traction control system according to claim 7, wherein each electric braking device includes a rotor that integrally rotates with the corresponding drive wheel, and a frictional member that approaches and separates from the rotor, wherein, when the frictional member is pressed against the rotor, brake is applied to the corresponding drive wheel, wherein the frictional member is movable among a basic position away from the rotor, a first braking position to generate the first braking force, a maximum braking position for generating the maximum braking force, and a braking standby position for releasing the corresponding drive wheel from braking, the braking standby position being between the basic position and the first braking position; and wherein, when at least one of the first to third conditions is satisfied, the controller moves the frictional member from the first braking position to the braking standby position.

11. The traction control system according to claim 10, wherein, when the drive wheel that has been released from braking has not stopped slipping, the controller again moves the frictional member from the braking standby position to the first braking position, and wherein, when the drive wheel that has been released from braking has stopped slipping, the controller moves the frictional member from the braking standby position to the basic position.

12. The traction control system according to claim 1, wherein each electric braking device includes:
a rotor that integrally rotates with the corresponding drive wheel;
a frictional member that approaches and separates from the rotor; and
an electric actuator for moving the frictional member, wherein the actuator presses the frictional member against the rotor, thereby applying brake to the corresponding drive wheel.

13. The traction control system according to claim 12, wherein the controller estimates braking force of each electric braking device based on at least one of the position of the corresponding frictional member, the value of current supplied to the corresponding electric actuator, the value of voltage supplied to the corresponding electric actuator, and the energization period to the corresponding electric actuator, and wherein the controller controls the electric braking device based on the estimated braking force.

14. The traction control system according to claim 1, further comprising a manual switch located in a passenger compartment of the vehicle, wherein, based on the state of the manual switch, the controller selectively activates and deactivates a control of the electric braking device corresponding to the slipping.

15. A traction control system for a vehicle having left and right drive wheels, the system comprising:
a pair of electric braking device, wherein each electric braking device corresponds to one of the drive wheels, and applies brake to the corresponding drive wheel, wherein each electric braking device includes:
a rotor that integrally rotates with the corresponding drive wheel;
a frictional member that approaches and separates from the rotor; and
an electric actuator for moving the frictional member, wherein the actuator presses the frictional member against the rotor, thereby applying brake to the corresponding drive wheel;
rotational speed sensors, each of which detects rotational speed of one of the drive wheels; and
a controller for controlling the electric braking devices, wherein, a difference between the rotational speeds detected by the rotational speed sensors exceeds a predetermined permissible value, the controller determines that the faster drive wheel is slipping, and causes the electric braking device corresponding to the faster drive wheel to generate braking force.

16. The traction control system according to Clam 15, wherein, when the rotational speed difference falls to or below the permissible value as a result of the application of brake to the drive wheel, the controller causes the electric braking device to stop applying brake.

17. The traction control system according to claim 15, wherein the controller causes the electric braking device corresponding to the slipping drive wheel to generate a first braking force, the first braking force being less than a maximum value of the braking force generated by the electric braking device.

18. The traction control system according to claim 17, wherein, until at least one of three conditions, which are: a first condition in which the drive wheel to which brake is being applied stops; a second condition in which the drive wheel to which brake is not being applied rotates; and a third condition in which a non-drive wheel of the vehicle rotates, is satisfied, the controller causes the electric braking device corresponding to the slipping drive wheel to generate the first braking force.

19. The traction control system according to claim 18, wherein, when at least one of the first to third conditions is satisfied, the controller reduces the braking force generated by the electric braking device from the first braking force to a second braking force, the second braking force being less than the first braking force.

20. The traction control system according to claim 19, wherein, when the drive wheel to which brake is being applied with the second braking force has not stopped slipping, the controller again increases the braking force generated by the electric braking device to the first braking force, and wherein, when the drive wheel to which brake is being applied with the second braking force has stopped slipping, the controller causes the electric braking device to stop applying brake.
